(19) United States
(12) Patent Application Publication
(10) Pub. No.: US 2005/0260001 A1
(43) Pub. Date: Nov. 24, 2005

(54) Burst signal receiver

(76) Inventor: Hiroshi Sakamoto, Yokohama (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/977,425

(22) Filed: Oct. 29, 2004

(30) Foreign Application Priority Data
May 24, 2004 (JP) 2004-153472

(51) Int. Cl. H04B 10/06

(52) U.S. Cl. 398/202

(57) ABSTRACT

A burst signal receiver that performs efficient signal conversion when burst optical signals received from various terminals differ in intensity. In a PON system, a photodiode is used to receive burst signals from subscriber terminals (ONUs). An OLT system informs a light-sensitive circuit of subscriber terminals (ONUs) that transmit burst signals, the order in which the burst signals are transmitted, and the timing for burst signal reception. A controller for the light-sensitive circuit uses a gain control table to obtain a gain and reference voltage for each subscriber terminal (ONU). In relation to the electrical current output from the photodiode, the controller converts the burst signals to digital signals using a gain and reference voltage with the reception timing indicated by the OLT system.

### BACKGROUND OF THE INVENTION

The present invention relates to a burst signal receiver, and more particularly to a burst signal receiver that is suitable for burst mode optical signal reception between a subscriber terminal and a station device.

In recent years, the speed and economical efficiency enhancement of a communication system has been seriously demanded due to the widespread use of the Internet. Therefore, the PON (Passive Optical Network) system, which is capable of transmitting a large amount of data, now attracts a good deal of attention. The PON system is one of the technologies for FTTH (Fiber To The Home) implementation. In the PON system, a station device (OLT: Optical Line Terminal) and an optical subscriber terminal (ONU: Optical Line Unit) are connected with optical fiber and optical couplers. As a signal transmission from the optical subscriber terminal to the station device, a burst optical signal based on TDMA (Time Division Multiple Access) is used.

The PON system will now be concretely outlined with reference to FIG. 4. As shown in FIG. 4, each subscriber terminal 10 is individually provided with an ONU 15. The ONUs 15 are subjected through optical fiber to optical branching/merging by an optical splitter 20. The optical fiber is connected to a station's OLT system 30. The downlink signal from the OLT system 30 to the ONUs 15 and the uplink signal from the ONUs 15 to the OLT system 30 provide single-conductor bidirectional optical transmission by using different wavelengths. For the downlink signal, a 622.08 Mbps or 155.52 Mbps continuous wave is used. For the uplink signal, a 155.52 Mbps burst wave passes through a single optical fiber cable. Upon receipt of the data that is transmitted from the OLT system 30 to the subscribers, each ONU 15 obtains its specific data from the received data.

As for the uplink signal, the signal transmission time is further time-multiplexed on an individual ONU basis as indicated in FIG. 5, and the transmission timing is adjusted so that the signals from the ONUs 15 do not collide with each other. The ONUs 15 then transmit data at their allocated times.

In the PON system, the signal to be received by the station's OLT system 30 is a burst signal whose intensity varies from one subscriber's ONU 15 to another. A conventional reception circuit will now be described with reference to FIG. 6. The optical signal received via optical fiber is converted into an electrical current signal by a photodiode PD. The resulting electrical current signal is then converted to a voltage signal by an amplifier AMP1. The obtained voltage signal is converted to the logical value 1 or logical value 0 by a comparator COMP. In this manner, a digital signal is derived from the received optical signal.

However, the intensity of the optical signal received by the photodiode PD greatly varies from one subscriber to another. Even if the signals transmitted from all ONUs 15 are equal in intensity, the signal intensity greatly varies due, for instance, to attenuation because the subscriber-to-station distance varies from one subscriber to another. Under these circumstances, a burst optical receiver for varying the threshold value in order to identify the logical value (1 or 0) of a received signal is disclosed (refer to JP-A No. 304202/2003 (pp. 1-2)).

The burst optical receiver described in JP-A No. 304202/2003 (pp. 1-2) comprises a photoelectric conversion element for converting a received burst digital optical signal to an electrical signal, an amplifier for amplifying the output of the photoelectric conversion element, a high-level peak detection circuit for detecting a high-level peak of a signal generated from the amplifier, and a low-level peak detection circuit for detecting a low-level peak of a signal generated from the amplifier. The high-level peak detection circuit and low-level peak detection circuit detect a high-level peak and low-level peak. Further, an A/D converter subjects the high-level peak and low-level peak to A/D conversion at the end of a preamble for a burst signal transmission from a subscriber and delivers its output to a midpoint potential calculator. The midpoint potential calculator calculates the intermediate value of a digital signal output from the A/D converter. The output from the midpoint potential calculator is converted to an analog signal by a D/A converter and then input into an identifier. The identifier compares the amplifier's output against a signal corresponding to the intermediate value to identify the logical level (1 or 0) of a signal received by the photoelectric conversion element. As a result, a burst optical receiver that provides high data transmission efficiency and facilitates circuit configuration is implemented.

However, the signals transmitted from the ONUs 15 greatly differ in intensity. As shown in FIG. 7, the current value generated from the photodiode PD varies over a wide range from approximately 0.2 μA to 200 μA. For conversion of such a wide range of current values, it is necessary to use a high-speed amplifier having a wide dynamic range and high gain. Particularly, it is very difficult to properly reproduce a small burst signal, which is subsequent to a great burst signal. If the gain is adjusted for such a small burst signal, the amplifier may become saturated. Therefore, when a signal transmitted at 156 Mbps is to be received, it is necessary to use a process that is far more rapid than a transmission rate of 156 Mbps. However, the use of such a process increases the cost.

The present invention solves the above problems and provides a burst signal receiver for performing steady signal conversion in a situation where the signals output from various subscribers differ in intensity.

### SUMMARY OF THE INVENTION

The present invention is a burst signal receiver that is connected to a light-sensitive element and a digital signal processing device to convert a burst signal to a digital signal. The light-sensitive element receives a burst signal that is time-multiplexed variously for all user terminals. The burst signal receiver comprises amplification means for amplifying a signal received by the light-sensitive element, comparison means for making a comparison with a logical value reference voltage and performing conversion to a logical value, and a controller for storing a gain setting for each terminal identifier. The controller acquires the terminal identifier of a user terminal for transmitting a burst signal and the information about a reception time for receiving the burst signal from the digital signal processing device, determines a gain setting for the amplification means in accordance with the terminal identifier, and informs the amplification means of the determined gain setting at the reception time.

The above configuration makes it possible to predetermine the gain setting and achieve amplification at a reception time. Therefore, even if the burst signal intensity varies from one user terminal to another, the gain can be effectively changed as needed. This ensures that the burst signal can be converted to a digital signal by using an amplifier having a relatively low gain characteristic.

According to the present invention, the controller sequentially acquires the terminal identifiers of user terminals, which transmit burst signals, from the digital signal processing device, and updates recordings. This makes it possible to sequentially predetermine the gain settings for incoming burst signals and perform amplification with increased efficiency and accuracy.

According to the present invention, the controller further stores a reference voltage setting for conversion to a logical value on an individual terminal identifier basis, determines a reference voltage setting for the comparison means in accordance with the terminal identifier acquired from the digital signal processing device, and informs the comparison means of the determined reference voltage setting at the reception time. This makes it possible to predetermine the reference voltage appropriate for the burst signal and perform conversion to a logical value with increased efficiency and accuracy.

According to the present invention, the controller further stores a bias voltage setting for each terminal identifier, determines the bias voltage setting in accordance with the terminal identifier acquired from the digital signal processing device, and informs the amplification means of the determined bias voltage setting at the reception time. This makes it possible to predetermine the bias voltage setting appropriate for the burst signal and perform amplification with increased efficiency and accuracy.

According to the present invention, the controller updates the gain setting recording for the terminal identifier whenever a burst signal is received from a user terminal. This makes it possible to properly convert the burst signal to a digital signal even if the user terminal condition is changed.

The present invention achieves signal conversion with high efficiency even if the burst signals received from various terminals differ in intensity.

### BRIEF DESCRIPTION OF THE DRAWINGS

FIG. 1 illustrates a station device according to the present invention.

FIG. 2 illustrates a light-sensitive circuit according to the present invention.

FIG. 3 is a timing diagram illustrating the operation of a light-sensitive circuit according to the present invention.

FIG. 4 is a schematic diagram illustrating a PON system.

FIG. 5 is a conceptual diagram illustrating an uplink signal that is used in a PON system.

FIG. 6 illustrates a conventional light-sensitive circuit.

FIG. 7 is a graph that indicates an electrical current value output from a photodiode.

### DETAILED DESCRIPTION OF THE INVENTION

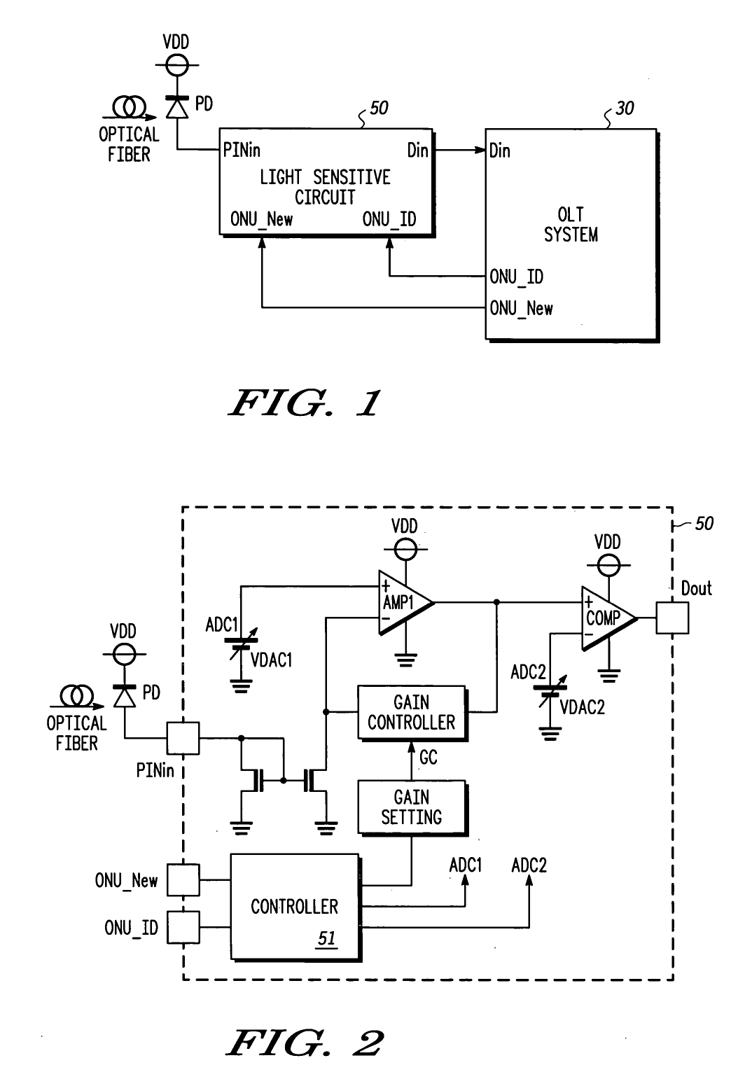

One embodiment of a burst signal receiver according to the present invention will now be described with reference to FIGS. 1 through 3. In the present embodiment, it is assumed that a PON system in which optical subscriber terminals (ONUs), which are user terminals, and a station device (OLT), which is a digital signal processing device, are connected with optical fiber to establish communication with a TDMA burst optical signal.

As shown in FIG. 1, an OLT system 30 comprises a light-sensitive circuit 50, which serves as a burst signal receiver. The light-sensitive circuit 50 includes a photodiode PD, which serves as a light-sensitive element. When a drive voltage Vdd is applied to the photodiode PD, the photodiode PD converts a burst signal, which is received via optical fiber, to an electrical current signal. The electrical current signal PINin enters the light-sensitive circuit 50.

The OLT system 30 knows beforehand the order in which the ONUs 15 transmit a burst signal. Next, an ONU_ID signal for identifying an ONU 15 from which a burst signal is to be transmitted is output as a terminal identifier for a user terminal that transmits a burst signal. Further, an ONU_NEW signal is output as reception timing information to indicate a time for receiving a burst signal from the next ONU 15.

The ONU_ID signal and ONU_NEW signal enter the light-sensitive circuit 50. The light-sensitive circuit 50 includes a controller 51 as shown in FIG. 2. The ONU_ID signal and ONU_NEW signal, which are transmitted from the OLT system 30, enter the controller 51. The controller 51 sequentially updates the ONU_ID signal record.

The controller 51 further comprises an internal memory, which stores a gain control table for setting a gain, reference voltage VDAC1, and reference voltage VDAC2 for each ONU 15. The gain control table stores a gain, reference voltage VDAC1, and reference voltage VDAC2 for each ONU_ID.

In accordance with the ONU_ID signal, the controller 51 uses the gain control table to acquire setup data for setting the gain, reference voltage VDAC1, and reference voltage VDAC2 for the burst signal of each ONU 15. Further, the controller 51 issues an instruction for outputting the gain, reference voltage VDAC1, and reference voltage VDAC2, which are acquired in accordance with the ONU_NEW signal, to a gain controller GC and variable-voltage supplies (ADC1 and ADC2), which are described later.

The electrical current signal PINin, which is output from the photodiode PD, enters the light-sensitive circuit 50. The electrical current value carried by the electrical current signal PINin is then converted to a voltage signal by an amplifier AMP1. In this instance, the gain controller GC performs gain setup in compliance with the instruction issued by the controller 51. In other words, the amplifier AMP1 and gain controller GC function as amplification means.

Variable voltage supply ADC1 is connected to the amplifier AMP1. Variable voltage supply ADC1 outputs reference voltage VDAC1 in compliance with instructions from the controller 51. The output signal generated from the amplifier AMP1 is converted to the logical value 1 or logical value 0 by a comparator COMP, which serves as comparison means. Variable voltage supply ADC2 is connected to the comparator COMP. Variable voltage supply ADC2 outputs reference voltage VDAC2 in compliance with instructions from the controller 51. Reference voltage VDAC2 is used as the logical value reference voltage for conversion to a logical value. The comparator COMP generates digital output Dout.

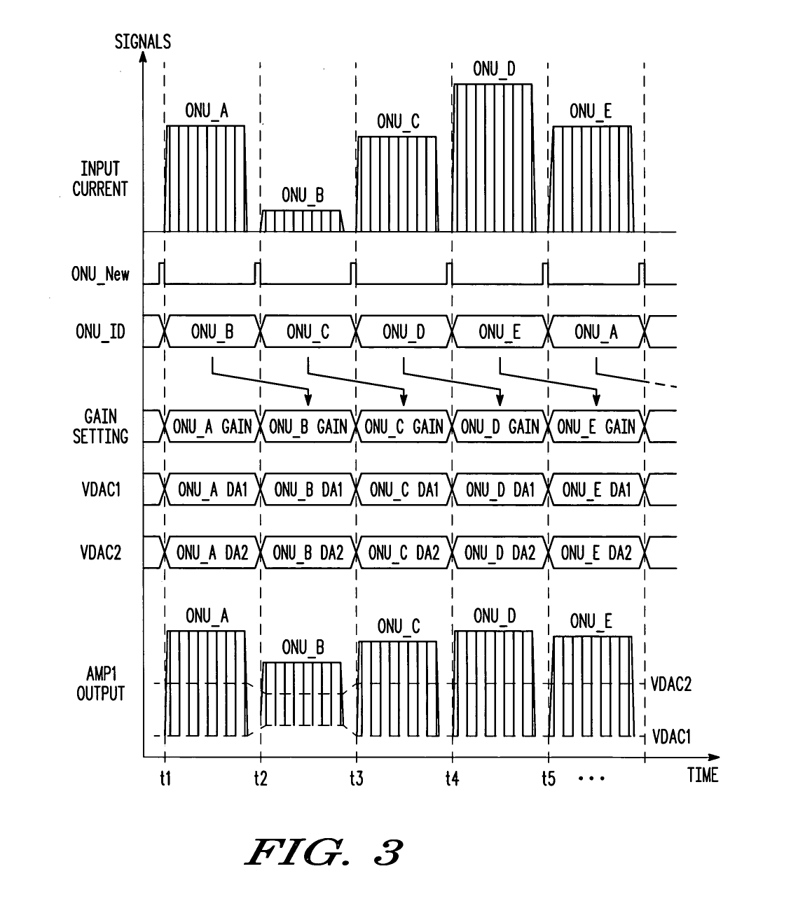

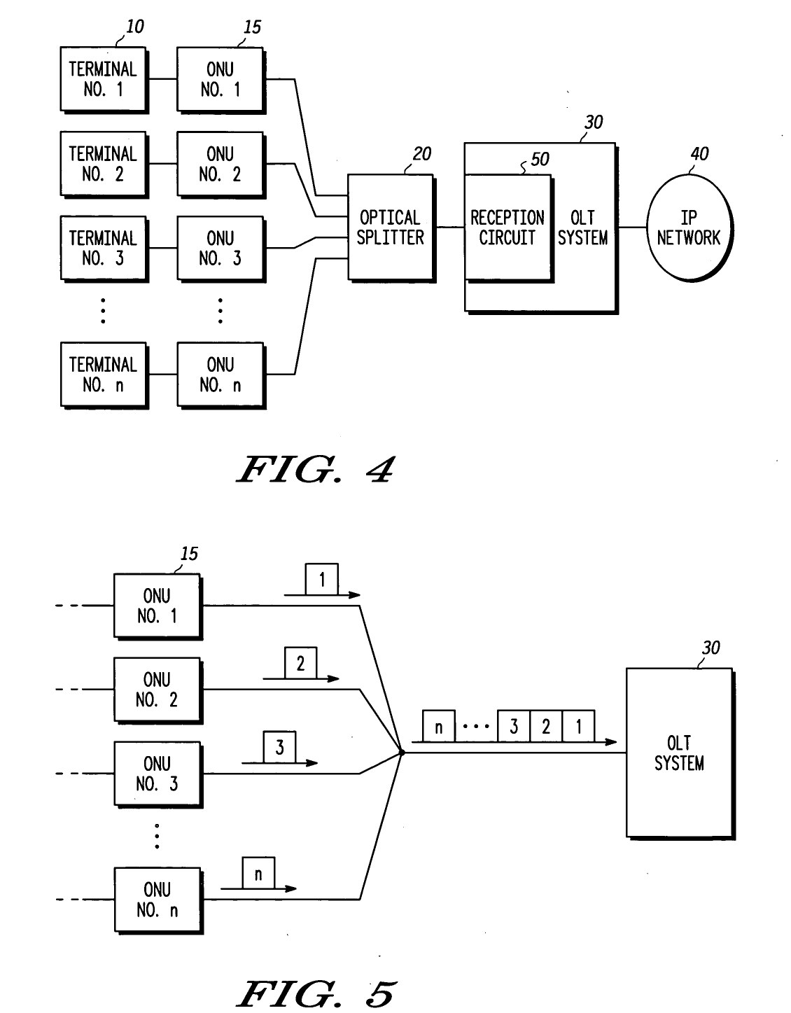

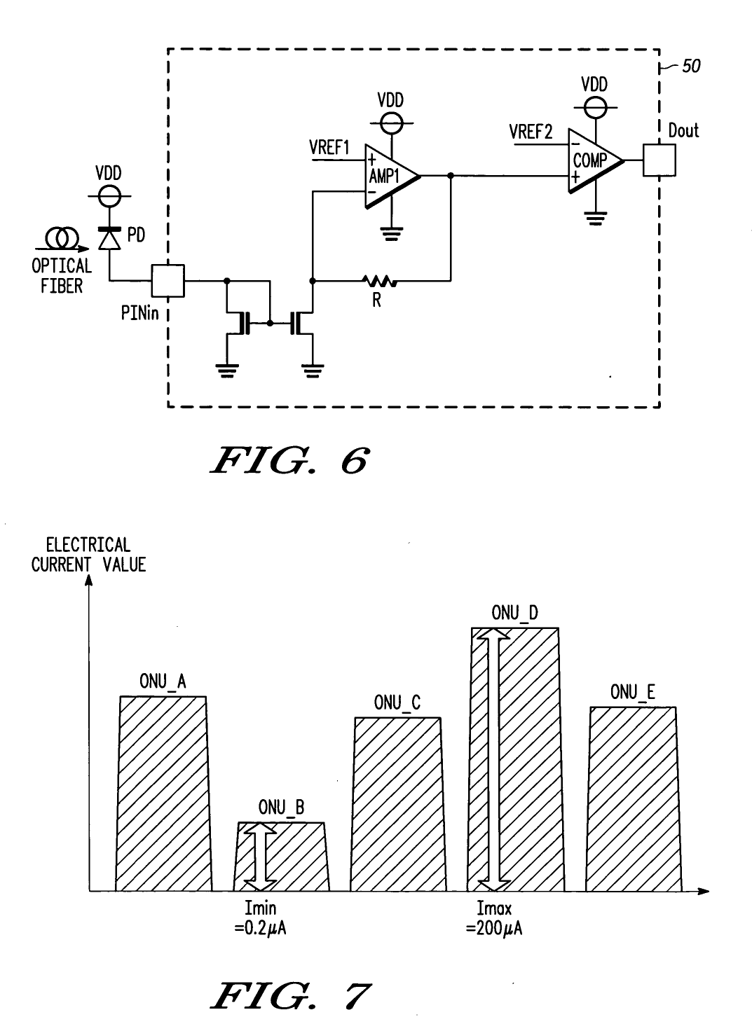

A timing diagram shown in FIG. 3 will now be used for explanation purposes. It is assumed that a burst signal is to be received from five ONUs (A through E). As described earlier, the OLT system 30 knows that a time-multiplexed burst signal is to be received from subscribers in the ONU_A, ONU_B, ONU_C, ONU_D, and ONU_E order. The OLT system 30 receives signals from the ONUs at times t1, t2, t3, t4, and t5.

The OLT system 30 transmits an ONU_NEW signal to the light-sensitive circuit 50 at times t1, t2, t3, t4, and t5. In this instance, the OLT system 30 supplies to the light-sensitive circuit 50 the ONU_ID signal of an ONU 15 that has transmitted the burst signal to be received next. For example, the ONU_A signal is received at time t1. In such an instance, the transmission indicates ONU_B as the ONU_ID. The ONU_B signal is received at time t2. In such an instance, the transmission indicates ONU_C as the ONU_ID. This transmission continues as far as the burst signal is received from the ONUs 15.

Upon receipt of the ONU_ID signal, the controller 51 acquires an appropriate gain, reference voltage VDAC1, and reference voltage VDAC2 and make preparations for setup by using the gain control table. Upon receipt of the next ONU_NEW signal, the controller 51 issues gain, reference voltage VDAC1, and reference voltage VDAC2 instructions to the gain controller GC, variable voltage supply ADC1, and variable voltage supply ADC2. During the interval between time t1 and time t2, for instance, the “ONU-A gain”, “ONU_A DA1”, and “ONU_A DA2” according to the burst signal from ONU_A are output. The controller 51 issues instructions concerning the “ONU_B gain”, “ONU_B DA1”, and “ONU_B DA2” that are acquired according to ONU_B, which is received at time t1, during an interval (between time t2 and t3) during which the next burst signal is received.

As a result, the output of the amplifier AMP1 is controlled by the gain controller GC, and biased by reference voltage VDAC1, which is generated by variable voltage supply ADC1. Meanwhile, the comparator COMP converts the output of the amplifier AMP1 to the logical value 1 or 0 by using reference voltage VDAC2, and outputs digital data Dout.

The features of the burst signal receiver, which is configured as described above, will now be described. In the present embodiment, the light-sensitive circuit 50 accepts the ONU_ID signal and ONU_NEW signal. The controller 51 in the light-sensitive circuit 50 uses the gain control table to set a gain and reference voltage VDAC1 as appropriate for the ONU_ID. This makes it possible to predict the burst signal intensity and set a bias voltage and gain accordingly.

In the present embodiment, the light-sensitive circuit 50 accepts the ONU_ID signal and ONU_NEW signal. The controller 51 in the light-sensitive circuit 50 uses the gain control table to set reference voltage VDAC2 as appropriate for the ONU_ID. This makes it possible to reduce the received data error rate in relation to the burst signal and achieve conversion to a logical value with increased efficiency.

The present invention is not limited to the foregoing embodiment, but is applicable to the following modifications. In the foregoing embodiment, the controller 51 includes an internal memory, which stores the gain control table for determining the gain, reference voltage VDAC1, and reference voltage VDAC2 for each ONU 15. However, the gain control table is not limited to the one that records data for each ONU 15 for the purpose of determining the gain, reference voltage VDAC1, and reference voltage VDAC2. Alternatively, a plurality of combinations of the gain, reference voltage VDAC1, and reference voltage VDAC2 may be prepared to let the OLT system 30 issue instructions for selecting an appropriate combination for the burst signal to be received next.

In the foregoing embodiment, the controller 51 includes an internal memory, which stores the gain control table for setting the gain, reference voltage VDAC1, and reference voltage VDAC2 for each ONU 15. The gain control table stores the gain, reference voltage VDAC1, and reference voltage VDAC2 for each ONU_ID. The gain control table may update the gain setting recording for a specific terminal identifier whenever a burst signal is received from a user terminal. More specifically, the gain control table may calculate the difference between the amplified signal intensity and standard signal intensity, and change the settings stored in the internal memory of the controller 51 so that the standard signal intensity is attained. This makes it possible to cope with transmission environment changes.

In the foregoing embodiment, a photodiode is used as a light-sensitive element. Alternatively, however, a phototransistor other light-sensitive element may be used.

### DESCRIPTION OF THE SYMBOLS

30: OLT system
50: Light-sensitive circuit
51: Controller
ADC1: Variable voltage supply
ADC2: Variable voltage supply
PD: Photodiode
GC: Gain controller
AMP1: Amplifier
COMP: Comparator

1. A burst signal receiver that is connected to a light-sensitive element for receiving a burst signal, which is time-multiplexed on an individual user terminal basis, and to a digital signal processing device in order to convert the burst signal to a digital signal, the burst signal receiver comprising:
amplification means for amplifying a signal received by said light-sensitive element:
comparison means for making a comparison with a logical value reference voltage and performing conversion to a logical value; and
a controller for storing a gain setting for each terminal identifier,
wherein said controller acquires the terminal identifier of a user terminal for transmitting a burst signal and the information about a reception time for receiving said burst signal from said digital signal processing device, determines a gain setting for said amplification means in accordance with said terminal identifier, and informs said amplification means of said determined gain setting at said reception time.

2. The burst signal receiver according to claim 1, wherein said controller sequentially acquires the terminal identifiers of user terminals, which transmit burst signals, from said digital signal processing device, and updates recordings.

3. The burst signal receiver according to claim 1, wherein said controller further stores a reference voltage setting for conversion to a logical value on all individual terminal identifier basis, determines a reference voltage setting for said comparison means in accordance with the terminal identifier acquired from said digital signal processing device, and informs said comparison means of said determined reference voltage setting at said reception time.

4. The burst signal receiver according to claim 1, wherein said controller further stores a bias voltage setting for each terminal identifier, determines said bias voltage setting in accordance with the terminal identifier acquired from said digital signal processing device, and informs said amplification means of said determined bias voltage setting at said reception time.

5. The burst signal receiver according to claim 1, wherein said controller updates the gain setting recording for said terminal identifier whenever a burst signal is received from a user terminal.
